(19) United States
(12) Patent Application Publication
(10) Pub. No.: US 2024/0414126 A1
(43) Pub. Date: Dec. 12, 2024

(54) NETWORK CRYPTOGRAPHIC ALGORITHM FIREWALL

(71) Applicant: Schneider Electric USA, Inc., Andover, MA (US)

(72) Inventor: Qing Sheng Han, Andover, MA (US)

(73) Assignee: Schneider Electric USA, Inc., Andover, MA (US)

(21) Appl. No.: 18/206,502

(22) Filed: Jun. 6, 2023

(51) Int. Cl. H04L 9/40

(52) U.S. Cl. CPC H04L 63/0245

(57) ABSTRACT

A method of providing a cryptographic algorithm firewall for an industrial control network is provided. The method includes receiving or determining a cryptographic algorithm configuration for determining which cryptographic algorithms are allowed, accessing packets flowing along a data path of the industrial control network, analyzing at least one packet of the accessed data packets to determine a cryptographic algorithm used for a network communication between two parties that is secured by application of the cryptographic algorithm, determining whether the cryptographic algorithm used for the network communication is allowed based on the received cryptographic algorithm configuration, and causing one or more actions related to the at least one packet's flow and/or the network communication in response to determining the cryptographic algorithm used for the network communication is not allowed.

### TECHNICAL FIELD

The present disclosure relates to industrial control networks, and more particularly, to provision of security to industrial control networks.

### BACKGROUND

Security provisions for an industrial control network (ICN) can include a firewall separation between the ICN and an external network, such as the Internet. One type of firewall separation uses a network layer firewall that inspects packet headers at a network level, known as layer 3 of the Open Systems Interconnection (OSI) model, which is a conceptual model used for coordination of standards development for the purpose of interconnection between systems.

Network layer inspection by the traditional firewall provides protection for vulnerabilities at the network layer, it does not provide protection for vulnerabilities at the transport layer (layer 4 of the OSI model) and above.

Another type of firewall separation uses an application layer firewall that provides protection for vulnerabilities at the application layer, known as layer 7 of the OSI model, by inspecting packet headers and/or application payload. Inspection of application data payload can include, for example, identification of an application function code or application data that is abnormal. However, the application layer firewall does not provide protection for vulnerabilities at the transport layer.

Vulnerabilities at the transport layer can occur when components internal to or external to the control network communicate use weak cryptographic algorithms, such as obsolete cryptographic algorithms (e.g. without limitation, RAS1024, SAH-1, RC4, DEC) or cryptographic algorithms that have been discovered by a watchdog agency, such as National Institute of Standards and Technology (NIST), to have a specific vulnerability.

While conventional methods and systems have generally been considered satisfactory for their intended purpose, there is still a need in the art for provision of protection to industrial control networks at the transport layer.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, disclosed is a method of providing a cryptographic algorithm firewall for an industrial control network implemented by one or more computers. The method includes receiving or determining a cryptographic algorithm configuration for determining which cryptographic algorithms are allowed, accessing packets flowing along a data path of the industrial control network, analyzing at least one packet of the accessed data packets to determine a cryptographic algorithm used for a network communication between two parties that is secured by application of the cryptographic algorithm, determining whether the cryptographic algorithm used for the network communication is allowed based on the received cryptographic algorithm configuration, and causing one or more actions related to the at least one packet's flow and/or the network communication in response to determining the cryptographic algorithm used for the network communication is not allowed.

In accordance with one or more embodiments, the method can further include providing a notification signal in response to determining the cryptographic algorithm is not an allowed cryptographic algorithm.

In accordance with one or more embodiments, the method can further include outputting a warning message responsive to the notification.

In accordance with one or more embodiments, the one or more actions related to the at least one packet's flow and/or the network communication can include blocking, dropping, diverting, or otherwise preventing the at least one packet and/or one or more packets of the network communication from continuing to flow along the data path of the industrial control network to its intended destination in response to determining the cryptographic algorithm is not allowed.

In accordance with one or more embodiments, the cryptographic algorithm configuration can be provided by a user or external processing device.

In accordance with one or more embodiments, the cryptographic algorithm configuration can be learned and refined over time.

In accordance with one or more embodiments, analyzing the accessed at least one packet can use session layer inspection.

In accordance with one or more embodiments, analyzing the at least packet can include inspecting data payload of a security handshake that occurs when the two parties negotiate cypher suites to use for the network communication.

In accordance with one or more embodiments, the at least one packet can be analyzed by a layer 3 firewall that performs network layer inspection in addition to being accessed by the cryptographic algorithm firewall.

In accordance with one or more embodiments, the cryptographic algorithm firewall can be integrated with or is coupled to the layer 3 firewall.

In accordance with one or more embodiments, the cryptographic algorithm configuration can be configured based on static features of the industrial control network.

In accordance with one or more embodiments, the cryptographic algorithm configuration can be updated based on information received during operation of the industrial control network.

In accordance with one or more embodiments, the method can further include blocking, dropping, or diverting a particular packet of the at least one packet and/or the one or more packets of the network communication, or otherwise preventing a packet of the at least one packet or the one or more packets of the network commination from continuing to flow along the data path of the industrial control network to its intended destination, if the particular packet has a self-signed certificate or is not encrypted.

In accordance with another aspect of the disclosure a cryptographic firewall for an industrial control network is provided. The cryptographic firewall includes at least one memory configured to store instructions and at least one processor disposed in communication with the at least one memory. The at least one processor upon execution of the instructions is configured to perform the operations of the method.

In accordance with still another aspect of the disclosure, one or more non-transitory computer readable storage mediums and one or more computer programs embedded therein are provided. The computer programs include instructions, which when executed by a computer system, cause the computer system to perform the operations of the method.

### BRIEF DESCRIPTION OF THE DRAWINGS

A more detailed description of the disclosure, briefly summarized above, may be had by reference to various embodiments, some of which are illustrated in the appended drawings. While the appended drawings illustrate select embodiments of this disclosure, these drawings are not to be considered limiting of its scope, for the disclosure may admit to other equally effective embodiments.

FIG. 1 is a schematic diagram illustrating an example industrial network protection system, including a cryptographic firewall, for providing protection to an industrial control network, in accordance with one or more embodiments of the disclosure;

FIG. 2 is a schematic view of the industrial network protection system shown in FIG. 2 in accordance with an example Purdue Model and in accordance with one or more embodiments of the disclosure;

FIG. 3 is a block diagram of the cryptographic firewall shown in FIG. 1, in accordance with one or more embodiments of the disclosure;

FIG. 4 is a flowchart of an example method performed by the cryptographic firewall, in accordance with one or more embodiments of the disclosure; and

FIG. 5 is a block diagram of an example computer system used for implementation of a cryptographic firewall shown in FIG. 1, in accordance with one or more embodiments of the disclosure.

Identical reference numerals have been used, where possible, to designate identical elements that are common to the figures. However, elements disclosed in one embodiment may be beneficially utilized on other embodiments without specific recitation.

### DETAILED DESCRIPTION

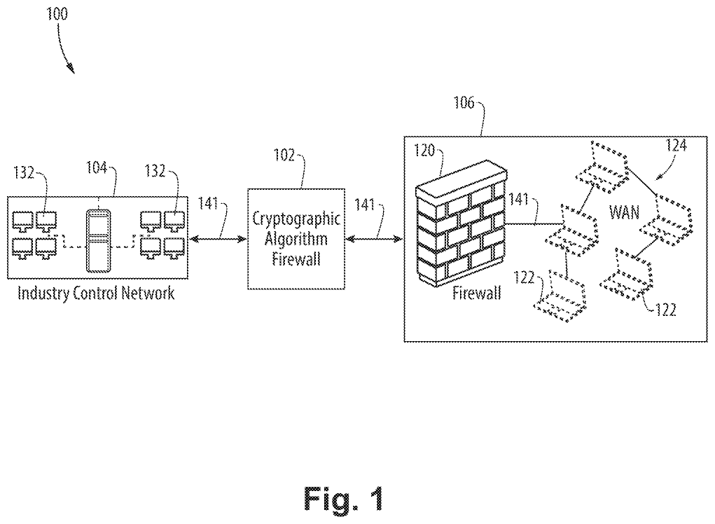

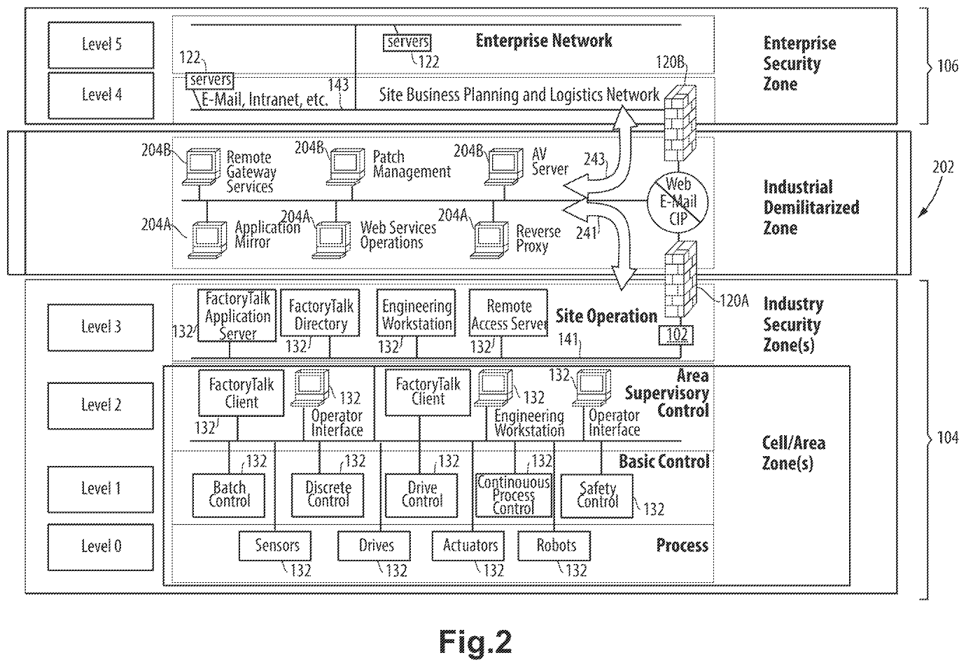

Reference will now be made to the drawings wherein like reference numerals identify similar structural features or aspects of the subject disclosure. For purposes of explanation and illustration, and not limitation, a block diagram of an exemplary embodiment of an industrial network protection system in accordance with the disclosure is shown in FIG. 1 and is designated generally by reference character 100. Other embodiments of the industrial network protection system 100 in accordance with the disclosure, or aspects thereof, are provided in FIGS. 2-5, as will be described.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth. It is to be appreciated the embodiments of this disclosure as discussed below are implemented using a software algorithm, program, or code that can reside on a computer useable medium for enabling execution on a machine having a computer processor. The machine can include memory storage configured to provide output from execution of the computer algorithm or program.

As used herein, the term “software” is meant to be synonymous with any logic, code, or program that can be executed by a processor of a host computer, regardless of whether the implementation is in hardware, firmware or as a software computer product available on a disc, a memory storage device, or for download from a remote machine. The embodiments described herein include such software to implement the equations, relationships, and algorithms described above. One skilled in the art will appreciate further features and advantages of the disclosure based on the above-described embodiments. Accordingly, the disclosure is not to be limited by what has been particularly shown and described, except as indicated by the appended claims.

The disclosure provides a method and system for provision of protection to an industrial control network at the transport layer and above by providing a network cryptographic algorithm firewall to detect usage of vulnerable cryptographic algorithms and to cause an action to be taken in response to detection of packets communicated to or from the industrial control network using a vulnerable cryptographic algorithm.

Description of certain illustrated embodiments of the present disclosure will now be provided. With reference now to FIGS. 1 and 2, industrial network protection system 100 includes a cryptographic firewall 102 that monitors packets communicated between an industry control network 104 and an external secured network 106. External secured network 106 includes one or more network firewalls 120 and an external network 124 having network components 122.

Industry control network 104 could potentially include legacy devices with cryptographic algorithms, such as RAS1024, SAH-1, RC4, DEC, etc. that were once adequate for providing secure encryption, but are presently considered to be vulnerable and unsecure. A vulnerability could be introduced to industrial network protection system 100 when, for example, a device 132 of industrial control network 104 is coupled with a legacy device using a vulnerable cryptographic algorithm. Devices 132 could further include a new control device which could still use vulnerable cryptographic algorithms, e.g., due to programmer mistakes. Additionally, even though industry control network 104 may include control devices that use cryptographic algorithms that are secure today, these same cryptographic algorithms may not comply with regulations (e.g., government, industry, or corporate regulations) or could be declared vulnerable one day in the future (e.g., by a watch dog agency, such as National Institute of Standards and Technology (NIST)). A sudden declaration of a vulnerability may warrant an immediate action to prevent potential malicious behavior that could take advantage of the vulnerability.

A traditional industry control network may include one or more traditional network firewalls that inspect packet headers at the network level (also referred to as Open Systems Interconnection (OSI) model layer 3) and/or one or more application firewalls that inspect packet headers and/or application payload at the application level (also referred to as OSI model layer 7). Inspection of application data payload can include, for example, identification of a function code or data that is abnormal. However, these firewalls would not inspect packets for data payload of secure handshakes that occur when two parties are negotiating cypher suites to use, and would not detect packets that use vulnerable cryptographic algorithms for network communication. Failure to detect use of vulnerable cryptographic algorithms could result in vulnerable network communications.

Accordingly, cryptographic firewall 102 is provided at an entrance to external secured network 106 for controlling which cryptographic algorithms are allowed to be used for network communication between external secured network 106 and industry control network 104. This network communication between a component of secured network 106 and a component of industry control network 104 is secured by application of a cryptographic algorithm. The cryptographic firewall 102 inspects packets flowing between external secured network 106 and industry control network 104, identifies the vulnerable cryptographic algorithms, and causes an action based on whether a vulnerable cryptographic algorithm is detected. The actions can include passing packets that do use a vulnerable cryptographic algorithm, blocking packets that do use a vulnerable cryptographic algorithm, and/or passing packets that do use a vulnerable cryptographic algorithm while sending an alert, etc.

FIG. 2 is a schematic view of the industrial network protection system 100 in accordance with a security model, such as the Purdue Model. In accordance with the Purdue Model, a physical or conceptual air gap is provided between industrial control network 104 and external network 124 by providing cryptographic firewall 102 and network firewalls 120 and associated servers. Using the Purdue Model as a reference, industrial control network 104 includes cell/area zones and industrial zones in which devices 132 of industrial control network 104 reside. External secured network 106 includes external network 124 (referred to as residing in an enterprise security zone) and an “industrial demilitarized zone” 202 that includes network firewall 120.

The air gap is provided within industrial demilitarized zone 202. Firewall 120 is shown having first and second respective network firewalls 120A and 120B. Communication between industry control network 104 and industrial demilitarized zone 202 along conceptual data paths 241 and 243 are monitored by cryptographic firewall 102 and network firewall 120A. In this way, cryptographic firewall 102 and network firewall 120A and hosts 204A monitor and handle communication along data path 241 on one side of the air gap. Network firewall 120b and hosts 204B monitor and handle communication along data path 243, between industrial demilitarized zone 202 and external network 124 on the other side of the air gap. Data that has been monitored by cryptographic firewall 102 and network firewalls 120A and 120B is exchanged between hosts 204A and hosts 204B of industrial demilitarized zone 202 to bridge the air gap without a direct flow of data between industry control network 104 and external network 106.

Industry control network 104 includes devices 132, which can include, for example, programmable logic controllers (PLCs) that provide, for example, batch control, discrete control, drive control, continuous process control, safety control, etc., and end devices, such as actuators and sensors, etc., that can be located in cell or area zones or in industrial security zones, including with remote access by a remote access server. All communication by all devices 132 with external network 106 in either direction must be processed by cryptographic firewall 102 and network firewalls 120.

While devices 132 may have internet access, all communication is monitored by cryptographic firewall 102 and network firewalls 120A and 120B. For example, an end device that has internet access can be limited to communication with a PLC that functions as an edge device. All of the PLC's communication with the internet is monitored by cryptographic firewall 102 and network firewalls 120A and 120B.

Network firewall 120 checks packet headers, e.g., an Ethernet (ETH) header, without checking packet payload. Network firewall 120 decides whether a packet is suspicious based on the information in the packet's header, such as source IP address, source port, destination IP address, and/or destination port. Network firewall 120 can decide how to treat the packet based on whether the inspection of the header results in a determination that the packet is suspicious.

On the other hand, cryptographic firewall 102 performs DPI to inspect the payload of packets used for secure communications. Secure communications, such as transport layer security (TLS) or datagram TLS (DTLS), start with a security handshake in which two or more parties exchange certificates and cipher suites for ongoing secured (meaning encrypted) communication. The information related to the certificates and cipher suites resides in the security handshake packets' respective payloads. Examples of information inspected using DPI can include identification of a secure protocol being used (e.g., DTLSv1.2), message length, type of message (e.g., Client Hello or Server Hello), names of cipher suites being offered by a client, names of cipher suites being accepted by a server.

Cryptographic firewall 120 inspects payload of the security handshake packets to identify which cryptographic algorithms are proposed for the ongoing communication between the parties. Cryptographic firewall 102 can then determine whether the identified cryptographic algorithms are allowed or not (based on a current configuration of cryptographic firewall 102), and take an action. The action can affect flow of the packet and/or send an alert to a system administrator.

FIG. 1 shows one or more embodiments that include a data path 141, formed of wired or wireless communication links, that extends at least between devices 132 of industry control network 104 and components 122 of secure external network 106. In one or more embodiments, cryptographic firewall 102 can be integrated with network firewall 120, such as by adding a feature to a legacy network firewall 120A. In one or more embodiments, cryptographic firewall 102 can be provided in a separate housing (e.g., in a separate box) from network firewall 120A. The box housing cryptographic firewall 102 can be positioned adjacent to the box housing network firewall 120A.

Cryptographic firewall 102 uses session layer inspection for determining which cryptographic algorithm is used for communication of the packet, whereas network firewall 120A uses a network layer inspection, such as for determining whether the packet source is malicious. The session and network layers are also referred to respectively as layers 5 and 3 by the Open Systems Interconnection (OSI) model. Since layer 5 inspection is a high-cost inspection that uses more resources (such as processing power, power consumption, and/or memory) than layer 3 inspection, the layer 5 inspection can be performed after the layer 3 inspection for purposes of efficiency. Thus, in one or more embodiments, cryptographic firewall 102 can be physically and/or logically positioned after network firewall 120A in order that packets flowing along data path 141 can be processed by cryptographic firewall 102 after being processed by network firewall 120A. The physical and/or logical positioning of cryptographic firewall 102.

Industrial control network 104 is a network of devices 132 that alone or together perform industrial tasks, such as operations performed within a factory, for energy production or refinement, for chemical production or refinement, etc. Devices 132 include smart devices configured to operate in one or more networked environments. Some of devices 132 can be sensors or actuators, and other devices 132 can be controllers that, for example, receive measurements from the sensors and control the actuators. Other devices can be workstations, servers,

Smart devices can include a processing device, such as a central processing unit (CPU), microprocessor, field programmable gate array (FPGA), application-specific integrated circuit (ASIC), digital signal processor (DSP), logic circuit, etc. Smart devices can be physical devices or virtual devices that are associated with a physical device. Examples of smart devices include servers, stationary computers, portable computers, mobile cellular phones, tablets, controllers (e.g., microcontrollers, PLCs, etc.), etc. Other examples of smart devices that could be used for devices 132 include devices having an embedded processor (e.g., a smart appliance, sensor, electrical component, etc.).

The one or more networked environments can facilitate communication amongst devices 132, between devices 132 of industrial control network 104 and components 122 of external secured network 106, and amongst components 122 of external secured network 106. The networked environment(s) can be implemented using one or more of a LAN, private or public WAN, VPN, enterprise network, or the like.

Network components 122 include smart devices configured to operate in the one or more networked environments. Network components 122 can be configured, for example, to form or be included in a WAN, such as an enterprise network. External network 124 includes network components 122, which can include, for example, an email server, file manager, internet access gateway, etc.

Cryptographic firewall 102 and network firewall 120 can be separate or combined computing devices that intercept or access packets traversing data path 141, perform inspection of the packets, analyze results of the inspection, and cause actions for handling the packets and/or for requesting alerts based on results of the analysis. The alert can be a warning message to the administrator and/or can signal another processor, which can prompt additional protective or precautionary actions. For example, the other processor can automatically take the additional protective or precautionary actions responsive to receiving the alert.

Hosts 204A and 204B can include one or more servers, switches, and/or additional computing devices within demilitarized zone 202 that is bounded by firewalls on both sides. Hosts 204A and 204B (forming the air gap formed there between) can be included along data path 141. A packet traversing data path 141 between industrial control zone 104 and external secured network 106 is processed by cryptographic firewall 102, network firewall 120A and network firewall 120B, and may be processed by hosts 204A and/or 204B when traversing between network firewall 120A and network firewall 120B.

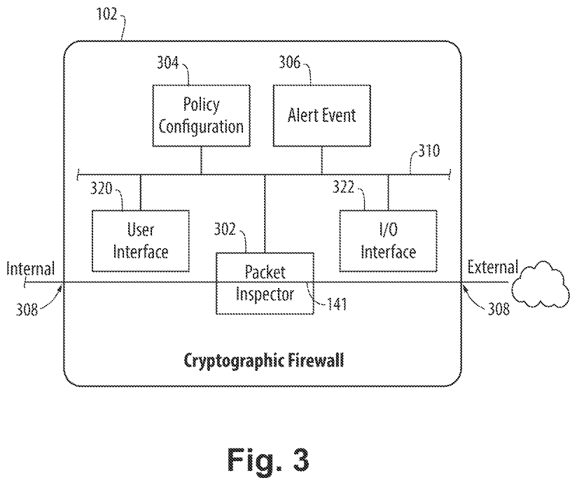

With reference to FIG. 3, cryptographic firewall 102 includes components such as a packet inspector 302, a policy configuration module 304, and an alert event module 306. The components can communicate with one another directly and/or via an internal data bus 310. Packet inspector 302 is configured by policy configuration module 304 for designating which cryptographic algorithms are acceptable. The configuration can be performed at the time of manufacturing, installation, or setup (e.g., by the system administrator), and can remain static or can be updated dynamically. In one or more embodiments, the system administrator can instruct the policy configuration module 304 via an optional user interface 320 to change the configuration. In one or more embodiments, a processor external to cryptographic firewall 102 can instruct the policy configuration module 304 via an optional I/O interface 322 to change the configuration, such as in response to instructions from the system administrator, analytics, or receipt of an external signal.

With regards to a static configuration, the configuration can be based on a security level (SL) of the industrial control network 104. In one or more embodiments, the configuration could be updated if the SL is changed. The configuration can additionally or alternatively be based on a customer requirement. In one or more embodiments, the configuration could be updated if the customer requirement is changed. For example, the customer may decide to allow packets using certain weak cryptographic algorithms to exit the packet inspector, but may require that an alert message be sent to the system administrator. The configuration can additionally or alternatively be based on a regulation governing cryptographic requirements, such as due to geographic location, as different countries may have particular requirements.

With regards to a dynamic configuration, policy configuration module 304 can receive real time updates via I/O interface 322, such as due to changes to the real time threat landscape. For example, policy configuration module 304 can subscribe to a vulnerability database that publishes cybersecurity vulnerabilities in real time (e.g., the U.S. National Institute of Standards and Technology (NIST) provides a national vulnerability database) to automatically obtain updates to the vulnerability database, e.g., by using use an application programming interface (API). These updates can be used to update the cryptographic algorithms allowed by configuration module 304. Accordingly, configuration module 304 can be updated in real time based on newly detected threats, regulatory changes (e.g., issued by a government agency), or policy changes (e.g., issued by corporate or industrial oversight agencies) . . . . Once configuration block 304 is updated, it can send new, allowable cryptographic algorithms to impacted devices 132 of industrial control network 104 to update their configurations to use the allowable cryptographic algorithms.

When packet inspector 302 determines that a packet uses a cryptographic algorithm that is not acceptable, packet inspector 302 can cause an action to occur that is related to the packet's flow, such as, without limitation, blocking, dropping, or diverting the packet. Blocking can refer to storing the packet, e.g., for future analysis without allowing the packet to arrive at its destination. Dropping can refer to not allowing the packet to arrive at its destination without saving or diverting the packet. Diverting the packet can refer to causing the packet to arrive at a different destination other than its intended destination, such as for analysis.

In addition, if it is determined that the packet has a self-signed certificate or is not encrypted, packet inspector 302 can cause the packet to be blocked, dropped, diverted, or otherwise prevented from continuing to flow along data path 141 to its intended destination. This action depends on a policy previously associated with handling self-signed certificates and plain text (meaning non-encrypted) communication.

Alternatively or additionally, packet inspector 302 can notify alert event module that an alert should be output. The alert can be displayed or can be an auditory noise that can be output via user interface 320. Alternatively or additionally, the alert can be a signal transmitted to a remote processing device (not shown). The signal can be output via I/O interface 322. The signal can cause the remote processing device to take an action (e.g., a protective or precautionary action), which can include controlling a device (e.g., devices 132 or components 122) and/or outputting a visual, auditory, and/or vibratory signal to a user. The remote process device can automatically disconnect an internal vulnerable device of industry control network 104 so that it is no longer connected to industry control network 104 and/or activate an alarm to alert the system administrator to the disconnection or to tell the system administrator to perform the disconnection. The remote processing device is external to the packet inspector 302 or cryptographic firewall 102.

Packet inspector 302 includes a deep packet inspection (DPI) software component for performing layer 5 inspection of packets traversing data path 141. Cryptographic firewall 102 can include a pair of input/output ports 308. Packets flowing along data path 141 enter one of the input/output ports 308 and exit the other input/output port 308. Packet inspector is coupled between the input/output ports 308 in order to have access to packets entering cryptographic firewall 102 via one of the input/output ports 308 to perform the layer 5 inspection before the packets exit cryptographic firewall 102 via the other input/output port 308 and continue to flow along data path 141. Packet inspector is configured to analyze the accessed packets to determine the cryptographic algorithm(s) used for communication of the packets, to allow the packets to exit cryptographic firewall 102 if the determined cryptographic algorithm(s) used for the communication are allowed, and to take one or more actions in response to determining the cryptographic algorithm(s) used for the communication is/are not allowed cryptographic algorithms.

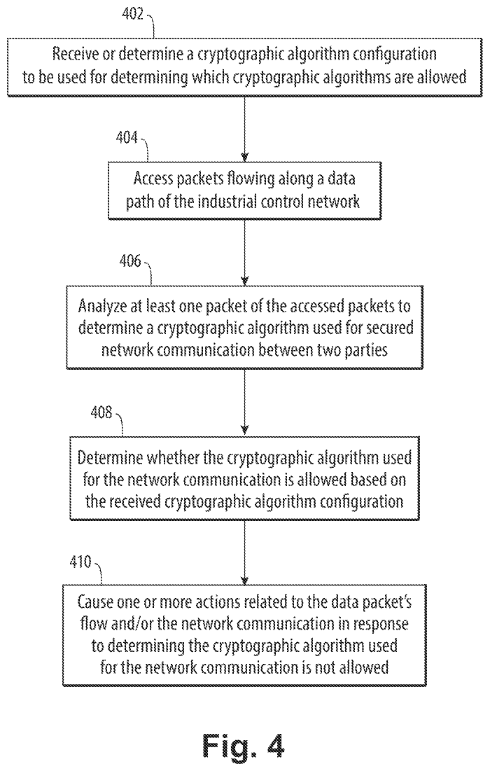

FIG. 4 shows exemplary and non-limiting flowcharts illustrating a method for implementing a cryptographic firewall for provision of security to industrial control networks, in accordance with certain illustrated embodiments. The method shown in FIG. 4 can be performed, for example, by cryptographic firewall 102. Before turning to the description of FIG. 4, it is noted that the flowchart in FIG. 4 shows examples in which operational blocks are carried out in a particular order, as indicated by the lines connecting the blocks, but the various blocks shown in these flowcharts can be performed in a different order, or in a different combination or sub-combination. It should be appreciated that in some embodiments some of the blocks described below may be combined into a single block. In some embodiments, one or more additional blocks may be included. In some embodiments, one or more of the blocks can be omitted.

With reference to FIG. 4, a flowchart is shown of an example method of implementing a cryptographic firewall. At block 402, a cryptographic algorithm configuration is received or determined for determining which cryptographic algorithms are allowed. At block 404, packets flowing along a data path of the industrial control network are accessed. At block 406, at least one packet of the accessed packets is analyzed to determine a cryptographic algorithm used for secured network communication between two parties. The at least one packet can include a security handshake that occurs when the two parties negotiate cypher suites to use for the network communication. The analysis can includes inspection of data payload of the security handshake that indicates which cypher suites are being offered and/or accepted during the negotiation.

At block 408, a determination is made whether the cryptographic algorithm used for the network communication (as determined by the analysis of the at least one packet) is allowed based on the received cryptographic algorithm configuration. At block 410, one or more actions related to the at least one packet's flow and/or the network communication is caused in response to determining the cryptographic algorithm used for the network communication is not allowed. Thus, the action can be directed at the at least one packet that includes the security handshake or at subsequent packets included in the network communication that includes the security handshake and can continue based on the security handshake being successful.

In one or more embodiments, block 402 can be implemented by a policy configuration module, such as policy configuration module 304 shown in FIG. 3. In one or more embodiments, blocks 404-410 can be implemented by a packet inspector, such as packet inspector 302 shown in FIG. 3.

The one or more actions related to the packet's flow can include, for example, blocking, dropping, or diverting the packet to prevent the packet from continuing to flow along the path of the industrial control network to its intended destination in response to determining the cryptographic algorithm is not allowed. In addition, the method can include blocking, dropping, or diverting the packet, or otherwise preventing the packet from continuing to flow along the path of the industrial control network to its intended destination, if the packet has a self-signed certificate or is not encrypted.

In addition to or alternative to causing an action related to the packet's flow, a notification signal can be sent in response to determining the cryptographic algorithm used for the communication of the packet is not allowed. The notification signal can cause a warning message to be output. The warning message can alert the system administrator and/or another processor (e.g., a remote processor), which can prompt additional protective or precautionary actions.

The cryptographic algorithm configuration can be provided by a user or external processing device. In addition or alternatively, the cryptographic algorithm configuration can be learned and refined over time. The cryptographic algorithm configuration can be configured based on static features of the industrial control network. In addition or alternatively, the cryptographic algorithm configuration can be updated based on information received during operation of the industrial control network, thus providing a dynamic cryptographic algorithm configuration.

Analyzing the accessed packet can use session layer inspection. In addition to the session layer inspection performed by the cryptographic firewall, the packet can be analyzed by a layer 3 firewall that performs network layer inspection. The cryptographic algorithm firewall can be integrated with or coupled to the layer 3 firewall.

Potential advantages are gained by providing a layer 5 inspection to detect packets communicated using cryptographic algorithm that are deemed unacceptable because they can introduce vulnerabilities.

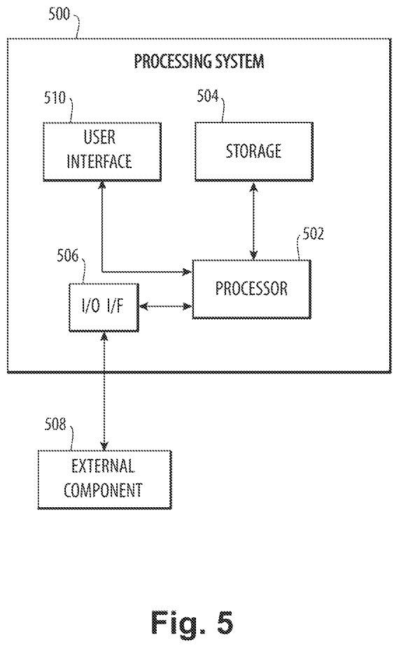

With reference to FIG. 5, a block diagram of an example computing system 500 is shown, which provides an example configuration for implementation of cryptographic firewall 102 and/or its components, packet inspector 302, policy configuration 304, alert event, ports 308, data bus 310, user interface 320, and I/O interface 322. Cryptographic firewall 102 and its components could be configured as software, firmware, or hardware, and computing system 500 could represent such portions. Computing system 500 is only one example of a suitable system and is not intended to suggest any limitation as to the scope of use or functionality of embodiments of the disclosure described herein. Computing system 500 can be implemented using hardware, software, and/or firmware. Regardless, computing system 500 is capable of being implemented and/or performing functionality as set forth in the disclosure.

Computing system 500 is shown in the form of a general-purpose computing device. Computing system 500 includes a processing device 502, memory 504, an input/output (I/O) interface (I/F) 506 (e.g., for implementing I/O interface 320 shown in FIG. 3) that can communicate with an internal component, such as a user interface 510 (e.g., for implementing user interface 320 shown in FIG. 3), and can optionally communicate with an external component 508.

The processing device 502 can include, for example, a programmable logic device (PLD), microprocessor, DSP, a microcontroller, an FPGA, an ASIC, and/or other discrete or integrated logic circuitry having similar processing capabilities.

The processing device 502 and the memory 504 can be included in components provided in the FPGA, ASIC, microcontroller, or microprocessor, for example. Memory 504 can include, for example, volatile and non-volatile memory for storing data temporarily or long term, and for storing programmable instructions executable by the processing device 502. Memory 504 can be a removable (e.g., portable) memory for storage of program instructions. I/O I/F 506 can include an interface and/or conductors to couple to the one or more internal components 510 and/or external components 508.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational operations to be performed on the computer, other programmable apparatus or other devices to produce a computer implemented process such that the instructions which execute on the computer or other programmable apparatus provide processes for implementing the functions/acts specified in the block diagram block or blocks.

Embodiments of the cryptographic firewall 102 may be implemented or executed by one or more computer systems, such as a microprocessor. Each computer system 500 can be included within processing components of cryptographic firewall 102, or multiple instances thereof. In the example shown, computer system 500 is embedded in computing devices of cryptographic firewall 102. The computer system 500 can be provided as an embedded device.

Computer system 500 is only one example of a suitable system and is not intended to suggest any limitation as to the scope of use or functionality of embodiments of the disclosure described herein. Regardless, computer system 500 is capable of being implemented and/or performing any of the functionality set forth hereinabove.

Computer system 500 may be described in the general context of computer system-executable instructions, such as program modules, being executed by a computer system. Generally, program modules may include routines, programs, objects, components, logic, data structures, and so on that perform particular tasks or implement particular abstract data types.

In the preceding, reference is made to various embodiments. However, the scope of the present disclosure is not limited to the specific described embodiments. Instead, any combination of the described features and elements, whether related to different embodiments or not, is contemplated to implement and practice contemplated embodiments. Furthermore, although embodiments may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

The various embodiments disclosed herein may be implemented as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer-readable medium(s) having computer-readable program code embodied thereon.

Any combination of one or more computer-readable medium(s) may be utilized. The computer-readable medium may be a non-transitory computer-readable medium. A non-transitory computer-readable medium may be, for example, but not limited to, an electronic, magnetic, optical, electromagnetic, infrared, or semiconductor system, apparatus, or device, or any suitable combination of the foregoing. More specific examples (a non-exhaustive list) of the non-transitory computer-readable medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. Moreover, such computer program code can execute using a single computer system or by multiple computer systems communicating with one another (e.g., using a local area network (LAN), wide area network (WAN), the Internet, etc.). While various features in the preceding are described with reference to flowchart illustrations and/or block diagrams, a person of ordinary skill in the art will understand that each block of the flowchart illustrations and/or block diagrams, as well as combinations of blocks in the flowchart illustrations and/or block diagrams, can be implemented by computer logic (e.g., computer program instructions, hardware logic, a combination of the two, etc.). Generally, computer program instructions may be provided to a processor(s) of a general-purpose computer, special-purpose computer, or other programmable data processing apparatus. Moreover, the execution of such computer program instructions using the processor(s) produces a machine that can carry out a function(s) or act(s) specified in the flowchart and/or block diagram block or blocks.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

We claim:

1. A method of providing a cryptographic algorithm firewall for an industrial control network implemented by one or more computers, wherein the method comprises:
receiving or determining a cryptographic algorithm configuration for determining which cryptographic algorithms are allowed;
accessing packets flowing along a data path of the industrial control network;
analyzing at least one packet of the accessed packets to determine a cryptographic algorithm used for a network communication between two parties that is secured by application of the cryptographic algorithm;
determining whether the cryptographic algorithm used for the network communication is allowed based on the received cryptographic algorithm configuration; and
causing one or more actions related to the at least one packet's flow and/or the network communication in response to determining the cryptographic algorithm used for the network communication is not allowed.

2. The method of claim 1, wherein the method further comprises providing a notification signal in response to determining the cryptographic algorithm is not an allowed cryptographic algorithm.

3. The method of claim 2, wherein the method further comprises outputting a warning message responsive to the notification.

4. The method of claim 1, wherein the one or more actions related to the at least one packet's flow and/or the network communication include blocking, dropping, diverting, or otherwise preventing the at least one packet and/or one or more packets of the network communication from continuing to flow along the data path of the industrial control network to its intended destination in response to determining the cryptographic algorithm is not allowed.

5. The method of claim 1, wherein the cryptographic algorithm configuration is provided by a user or external processing device.

6. The method of claim 1, wherein the cryptographic algorithm configuration is learned and refined over time.

7. The method of claim 1, wherein analyzing the at least one packet uses session layer inspection.

8. The method of claim 7, wherein analyzing the at least packet includes inspecting data payload of a security handshake that occurs when the two parties negotiate cypher suites to use for the network communication.

9. The method of claim 1, wherein the at least one packet is analyzed by a layer 3 firewall that performs network layer inspection in addition to being accessed by the cryptographic algorithm firewall.

10. The method of claim 9, wherein the cryptographic algorithm firewall is integrated with or is coupled to the layer 3 firewall.

11. The method of claim 1, wherein the cryptographic algorithm configuration is configured based on static features of the industrial control network.

12. The method of claim 1, wherein the cryptographic algorithm configuration is updated based on information received during operation of the industrial control network.

13. The method of claim 1, further comprising blocking, dropping, or diverting a particular packet of the at least one packet and/or the one or more packets of the network communication, or otherwise preventing a packet of the at least one packet or the one or more packets of the network communication from continuing to flow along the data path of the industrial control network to its intended destination, if the particular packet has a self-signed certificate or is not encrypted.

14. A cryptographic firewall for an industrial control network, comprising:
at least one memory configured to store a plurality of programmable instructions; and
at least one processing device in communication with the at least one memory, wherein the at least one processing device, upon execution of the plurality of programmable instructions is configured to:
determine which cryptographic algorithms are allowed;
access packets flowing along the data path;
analyze at least one packet of the accessed packets to determine a cryptographic algorithm used for a network communication between two parties that is secured by application of the cryptographic algorithm;
determine whether the cryptographic algorithm used for the network communication is allowed based on the received cryptographic algorithm configuration; and
cause one or more actions related to the at least one packet's flow and/or the network communication in response to determining the cryptographic algorithm used for the network communication is not allowed.

15. The cryptographic firewall of claim 14, wherein the one or more actions related to the at least one packet's flow and/or the network communication include blocking, dropping, diverting, or otherwise preventing the at least one packet and/or one or more packets of the network communication from continuing to flow along the data path of the industrial control network to its intended destination in response to determining the cryptographic algorithm is not allowed.

16. The cryptographic firewall of claim 14, wherein analyzing the at least one packet uses session layer inspection.

17. The cryptographic firewall of claim 16, wherein analyzing the at least packet includes inspecting data payload of a security handshake that occurs when the two parties negotiate cypher suites to use for the network communication.

18. The cryptographic firewall of claim 14, wherein the at least one packet is analyzed by a layer 3 firewall that performs network layer inspection in addition to being accessed by the cryptographic algorithm firewall.

19. The cryptographic firewall of claim 14, wherein the cryptographic algorithm firewall is integrated with or is coupled to the layer 3 firewall.

20. The cryptographic firewall of claim 14, wherein the cryptographic algorithm configuration is updated based on information received during operation of the industrial control network.

21. One or more non-transitory computer readable storage mediums and one or more computer programs stored therein, the computer programs comprising instructions, which when executed by a computer system, cause the computer system to:
determine which cryptographic algorithms are allowed
access data packets flowing along the data path;
analyze at least one packet of the accessed packets to determine a cryptographic algorithm used for a network communication between two parties that is secured by application of the cryptographic algorithm;
determine whether the cryptographic algorithm used for the network communication is allowed based on the received cryptographic algorithm configuration; and
cause one or more actions related to the at least one packet's flow and/or the network communication in response to determining the cryptographic algorithm used for the network communication is not allowed.
